(19) United States
(12) Patent Application Publication
(10) Pub. No.: US 2008/0035754 A1
(43) Pub. Date: Feb. 14, 2008

(54) Device for Treating Object and Process Therefor

(75) Inventors: Michio Aruga, Kanagawa (JP); Koichi Saito, Kanagawa (JP); Kaori Tajima, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: AQUA SCIENCE CORPORATION, KANAGAWA (JP)

(21) Appl. No.: 11/660,477

(22) PCT Filed: Jul. 21, 2005
(86) PCT No.: PCT/JP05/13372

§ 371 Date: Mar. 14, 2007

(30) Foreign Application Priority Data
Aug. 20, 2004 (JP) 2004-241004

(51) Int. Cl. B05B 3/00

(52) U.S. Cl. 239/97

(57) ABSTRACT

Disclosed is a system for treating an object, comprising a section for positioning an object on which the object to be treated is positioned under a predetermined atmosphere; a nozzle section for spraying the object with supplied vapor and water in mixture; means for moving the section for positioning an object and/or the nozzle section for allowing the nozzle section to spray the object on the section for positioning an object; means for controlling positional relationship between the section for positioning an object and the nozzle section to control relative rate (scan rate); and means for controlling, during the spraying, each of parameters of pressure of the vapor supplied to the nozzle section, flowrate of the water supplied to the nozzle section, area of an outlet of the nozzle section, spray time, scan rate and gap between the outlet of the nozzle section and the object.

### TECHNICAL FIELD

The present invention relates to a device or process for treating objects such as semiconductor substrates, glass substrates, lenses, disc members, precision-machined members and molded resin members at their predetermined portions or surfaces, the device or process performing, as treatments of such objects, cleaning of their portions and surfaces, removal and peeling off of unwanted matters therefrom as well as polishing and processing of their surfaces. More specifically, the present invention relates to a device or process for efficiently peeling off or removing unwanted matters in an etching step, such as reaction byproducts and/or so-called sidewall protective films produced from films to be etched, among systems and processes for removing unwanted matters produced in a process for fabricating semiconductors and the like in which microstructures are created on surfaces of an object.

### BACKGROUND ART

### Problems of the Prior Art

Description will be made here by way of example of a process for fabricating semiconductors. In an etching step of semiconductor fabrication, secondary reaction byproducts are produced from films to be etched. In general, since such reaction byproducts have sidewall protective effects, they are likely to be utilized by a procedure such as profile control. In a subsequent peeling off step, a procedure is generally performed in which dry plasma ashing or a chemical solution is applied to peel off or remove the reaction byproducts.

However, for devices for treating objects for removing (peeling off) unwanted matters being produced in a process for producing such products, though some of such devices are subjected to a conventional procedure or a procedure different from general procedures, reaction byproducts from a film to be etched cannot be removed by such a conventional procedure, often allowing a residue product to be present in the form of a fence (wall). Also, in some cases, such a removal (peeling off) step is not performed before proceeding to a subsequent step, providing commercial products with residual films present.

In recent processes for producing semiconductors, in accompaniment with development and changes of object film species in micromachining, a number of problems such as planarity of devices and electrode defects have arisen due to the formation of asperities on the surfaces of products imparted by residual films from the reaction byproducts. As such, yields of products have finally become unignorable and there is a need for developing a novel technology for more efficiently removing residual films of reaction byproducts.

### Problems of Conventional Systems

It is difficult to remove such fences by peeling off procedures according to conventional system. In conventional system, treatment with plasma or a liquid chemical is performed. In general, the ratio of chemical factors is high so that a great amount of time will presumably be needed for selecting conditions for fence removal, making a practical application problematic. Also, even if a peeling off procedure was established on the basis of a conventional system, investment on supply installations, purchase of liquid chemicals, treatment installations and the like as well as running costs for such installations would predictably be huge.

### Problems of Other System

Other generally used removal processes include water jet scrubber, submerged reflux by lot treatment, high-pressure water spurting and the like. With these removal processes, however, it is difficult to strictly control factors on a wafer (object), with a result that desired removal of residual films has not yet been attained. Also, with use of high-pressure water spurting, though peeling off may be possible, controllability and damages to a wafer (object) will remain as significant problems.

### DISCLOSURE OF THE INVENTION

### Problems to be Solved by the Invention

As discussed above, description has been made by way of example of a process for fabricating semiconductors as a device or process for treating an object.

Conventional systems for treatment in the field of semiconductor devices, however, have a disadvantage that unwanted matters (residue products) composed of reaction byproducts are highly difficult to remove.

In view of such a disadvantage, the present invention is intended to provide a process or method for treating objects that is capable of more reliably and efficiently performing, in relation to an object having portions or surfaces to be treated, treatments such as cleaning of the portions or surfaces, removal and peeling off of unwanted matters therefrom as well as polishing and processing of the surfaces and is applicable to objects to be treated in more variety of fields of semiconductor substrates (silicon and the like), glass substrates such as those for liquid crystals, lens products for cameras, disks such as CDs and DVDs, precision-machined components as well as molded parts.

### Means for Solving the Problems

(1) A device for treating an object comprises

a section for positioning an object (for example, stage section) on which the object is placed under a predetermined atmosphere;

a nozzle section for spraying the object with supplied vapor and water (which may be pure water or ultrapure water) in mixture; and

means for controlling relative rate of travel (scan rate) to a desired value during the spraying while moving the nozzle section in relation to the object on the section for positioning an object by regularly changing positional relationship between the section for positioning an object and the nozzle section.

During the spraying, each of parameters of pressure of the vapor supplied to the nozzle section, flowrate of the water supplied to the nozzle section, area of an outlet of the nozzle section, spray time, relative rate (scan rate) and gap between the outlet of the nozzle section and the object is controlled.

Values of the parameters may be controlled to so that

the pressure of the vapor supplied to the nozzle section is from 0.1 to 0.5 MPa,

the flowrate of the ultrapure water supplied to the nozzle section is from 50 to 1000 cc/min,

the spray time is from 10 to 600 sec,

the area of an outlet of the nozzle section is from 1 to 100 mm²,

the scan rate is from 10 to 300 mm/sec, and

the gap between the nozzle outlet and the object is from 3 to 30 mm.

Also, the outlet of the nozzle section may have a variety of profiles, such as round, square, rectangular, flattened rectangular, elliptical, flattened elliptical and slit-like profiles.

(2) In the device for treating an object according to (1), the object is any one of a semiconductor substrate, glass substrate, lens, disk member, precision-machined member and molded resin member, and

the treatment of the object is cleaning of a portion or surface to be treated or removal of unwanted matters present on the portion or surface.

(3) In the device for treating an object according to (1) or (2), the section for positioning an object is provided with a stage type positioning member or a conveyor type positioning member for performing one or more of rotation, revolution and transfer.

An example of a stage type positioning member includes a stage section on which the object is placed (mounted) for performing rotation or revolution about an axis. Also, an example of a conveyor type positioning member includes a conveyor belt for performing transfer or transportation wherein the object is placed (mounted) on a movable belt.

(4) In the device for treating an object according to (1) to (3), the object is a semiconductor device having any one of a highly dielectric layer, a passivation film and a metal layer as the portion or the surface to be treated, and

the system is characterized in that it removes, as an unwanted matter, any one of

1) a reaction byproduct produced after treating the highly dielectric layer with etching,

2) a reaction byproduct produced after treating the passivation film with etching, and

3) a reaction byproduct produced after treating the metal layer with etching.

(4-1) In the device for treating an object according to (4), the object is a semiconductor device having a highly dielectric layer as a layer to be treated,

the unwanted matter is a reaction byproduct produced after treating the highly dielectric layer with etching, and

the spraying may be controlled so that

the vapor has a temperature of 100° C. or higher and a pressure of from 0.2 to 0.3 MPa,

the ultrapure water has a flowrate of from 100 to 500 cc/min,

the nozzle section has an outlet area of from 1 to 100 mm²,

the spray time is from 120 to 300 sec,

the scan rate is from 40 to 100 mm/sec, and

the gap is from 5 to 30 mm.

(4-2) In the device for treating an object according to (4), the object is a semiconductor device having a passivation film,

the unwanted matter is a reaction byproduct produced after treating the passivation film with etching, and

the spraying may be controlled so that

the vapor has a temperature of 100° C. or higher and a pressure of from 0.15 to 0.3 MPa,

the ultrapure water has a flowrate of from 100 to 500 cc/min,

the nozzle section has an outlet area of from 1 to 100 mm²,

the spray time is from 60 to 120 sec,

the scan rate is from 40 to 100 mm/sec, and

the gap is from 5 to 30 mm.

(4-3) In the device for treating an object according to (4), the object is a semiconductor device having a metal layer,

the unwanted matter is a reaction byproduct produced after treating the metal layer with etching, and

the spraying may be controlled so that

the vapor has a temperature of 100° C. or higher and a pressure of from 0.1 to 0.2 MPa,

the ultrapure water has a flowrate of from 100 to 500 cc/min,

the nozzle section has an outlet area of from 1 to 100 mm²,

the spray time is from 30 to 120 sec,

the scan rate is from 40 to 100 mm/sec, and

the gap is from 5 to 30 mm.

(5) A process for treating an object comprises the steps of

positioning an object on a section for positioning an object under a predetermined atmosphere;

spraying the object with supplied vapor and water in mixture through a nozzle section; and

controlling relative rate of travel (scan rate) to a desired value during the spraying while moving the nozzle section in relation to the object on the section for positioning an object by regularly changing positional relationship between the section for positioning an object and the nozzle section.

During the spraying, each of parameters of pressure of the vapor supplied to the nozzle section, flowrate of the water supplied to the nozzle section, area of an outlet of the nozzle section, spray time, relative rate (scan rate) and gap between the outlet of the nozzle section and the object is controlled.

Values of the parameters may be controlled to so that

the pressure of the vapor supplied to the nozzle section is from 0.1 to 0.5 MPa,

the flowrate of the ultrapure water supplied to the nozzle section is from 50 to 1000 cc/min,

the spray time is from 10 to 600 sec,

the area of an outlet of the nozzle section is from 1 to 100 mm²,

the scan rate is from 10 to 300 mm/sec, and

the gap between the nozzle outlet and the object is from 3 to 30 mm.

Each term as used herein will be described below with respect to the definitions thereof. The term “object” is not particularly specified and includes a semiconductor substrate, glass substrate, lens, disk member, precision-machined member and molded resin member, for example. The term “treatment” is not particularly specified as long as it is applied to an object, and includes peeling off, cleaning and processing, for example. The term “unwanted matter” means any of unwanted matters as produced during treatment of an object, examples of which include a resist film, etching residue after dry etching and a chemically modified resist film, for a process for fabricating semiconductor devices.

### EFFECT OF THE INVENTION

According to the device and process for treating an object of the present invention, vapor (water vapor) and water (which may be pure water or ultrapure water) at a high pressure are mixed in a nozzle before being spurted against an object such as a wafer and, during such spurting (blowout), various parameter conditions are specified so that treatment time may precisely be controlled in conjunction with a circumferential velocity control system, therefore, enabling extremely effective treatment of the object. Used as parameters here are vapor pressure conditions, DIW (pure water) flowrate, outlet area of a nozzle section, distance between a nozzle and the object (such as wafer), removal (treatment) time and scan rate.

Examples of treatments of objects according to the present invention include cleaning predetermined portions or surfaces of semiconductor substrates, peeling off or removing unwanted matters or foreign substances such as reaction byproducts, cleaning glass substrates for liquid crystals and removing foreign substances therefrom, cleaning camera lenses and removing foreign substances therefrom, removing foreign substances from machined components and deburring molded resins. The present invention is especially suitable for treating objects composed of materials not agreeable with chemicals.

Also, according to the present invention, in comparison to conventional high pressure water spurting processes, since peeling off is enabled at lower pressures, damages to objects such as wafers may be suppressed and since the principal component for peeling off is water, oversized investment may be avoided and running costs may greatly be reduced.

### BRIEF DESCRIPTION OF THE DRAWINGS

FIG. 1 is an overall view of a device for treating objects according to one embodiment of the present invention.

FIG. 2 is a sectional view illustrating nozzle configurations according to one embodiment of the present invention.

FIG. 3 is a view illustrating operation of a nozzle section and a stage section (section for positioning an object) according to one embodiment of the present invention.

FIG. 4 shows views for illustrating relative operational situations (scan situations) on an object according to one embodiment of the present invention.

FIG. 5 shows sectional views of an object 500 according to one embodiment of the present invention.

FIG. 6 shows sectional views of an object 600 according to one embodiment of the present invention.

FIG. 7 shows sectional views of an object 700 according to one embodiment of the present invention.

### BEST MODE FOR CARRYING OUT THE INVENTION

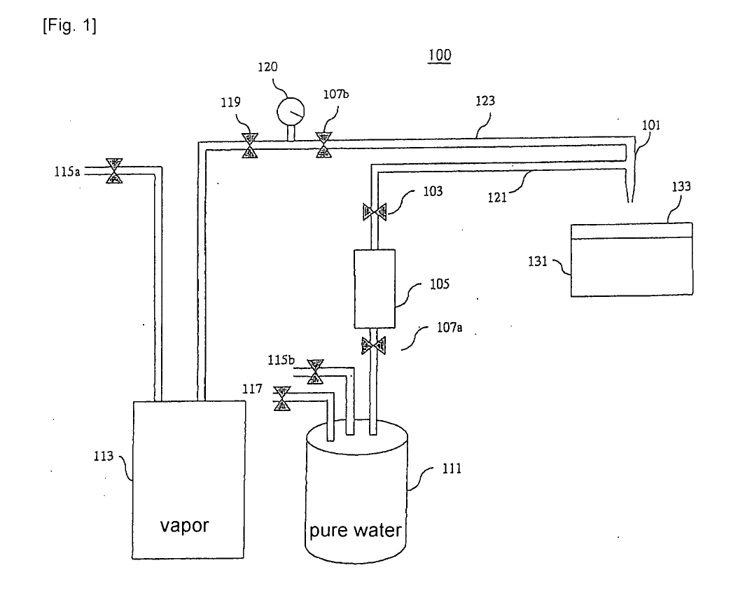

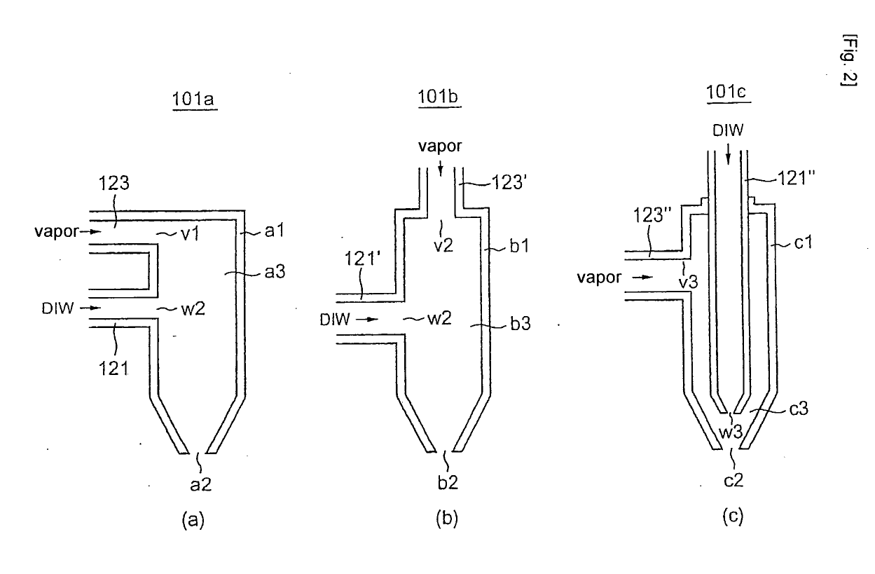

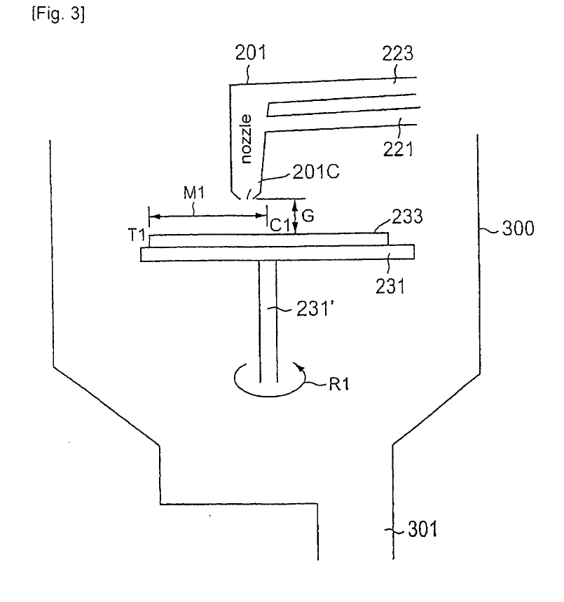

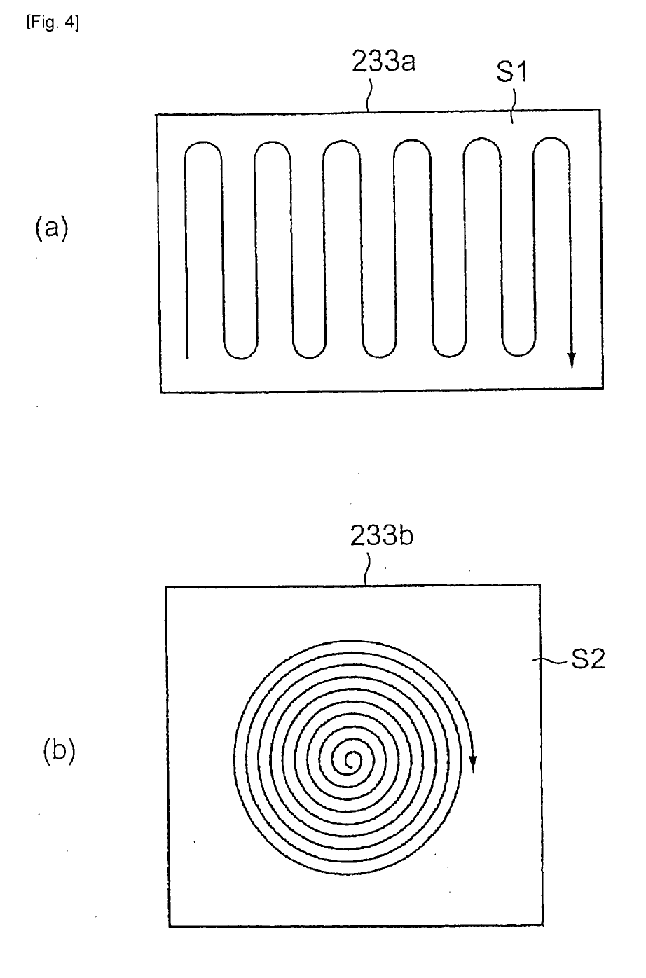

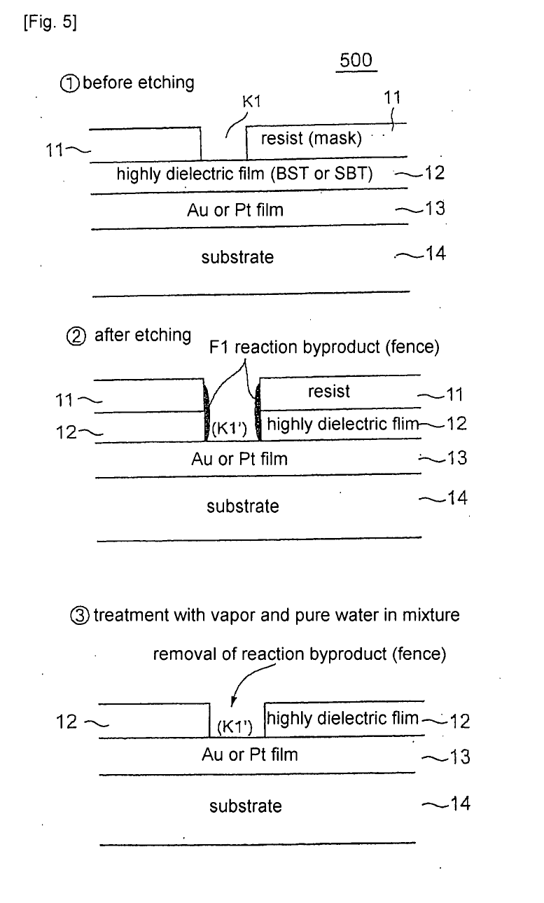

An embodiment of the present invention will be described below with reference to drawings, wherein FIG. 1 is an overall view of a system for treating objects according to one embodiment of the present invention, FIG. 2 is a sectional view illustrating nozzle configurations to be used for one embodiment of the present invention, FIG. 3 is a view illustrating operational control of a nozzle section and a stage section (section for positioning an object) according to one embodiment of the present invention, FIG. 4 shows views for illustrating situations for scanning an object by a nozzle according to one embodiment of the present invention, and FIGS. 5 to 7 show views illustrating objects being treated in section according to one embodiment of the present invention.

Device for Treating Object According to the Present Invention

Basic Principles

When pure water at an ordinary temperature (about 20° C.) and water vapor at an elevated temperature (100° C. or higher) are continuously mixed in a container having a constant capacity under a constant pressure, the pure water will be heated by the water vapor to expand while the water vapor will be cooled by the pure water to shrink. Through such heat exchange, oscillation having a certain frequency (10 KHz to 1 MHz) will be produced.
Pure water (about 20° C.)+water vapor (100° C. or higher)→oscillation

This oscillation will break a water molecule, H₂O, into a hydrogen ion H⁺ and a hydroxide ion OH⁻.
H₂O→H⁺+OH⁻

Since the hydrogen ion H⁺ and hydroxide ion OH⁻ are in a very unstable state, they will tend to revert to a water molecule, H₂O. Energy produced during such reversion is transformed to mechanical impact to clean objects to be treated.

According to the present invention, this basic principle (thermal effect phenomenon) is utilized to produce cavitation to thereby perform treatments such as removal of unwanted matters on the surfaces of the objects to be treated. Examples of such unwanted matters for semiconductor devices include reaction byproducts produced after treating highly dielectric layers with etching, reaction byproducts produced after treating passivation films also with etching and reaction byproducts produced after treating metal layers also with etching.

General Configuration of Device for Treating Object

FIG. 1 is an overall view of a device 100 for treating objects according to one embodiment of the present invention.

The system 100 comprises a nozzle 101, an operative valve 103, a water flowmeter 105, stop valves 107a and 107b, a water-pressurizing tank 111, a water vapor supplier 113, water supply pipes 115a and 115b, a nitrogen supply pipe 117, a pressure reducing valve 119, pressure hoses 121 to 123 and a stage 131. Positioned and fixed on the stage 131 is an object to be treated (here referred to as “wafer”) 133. The nozzle 101 is positioned in such a manner that it may face and spurt against a surface to be treated of the object to be treated 133 and produces cavitation jet.

The water-pressurizing tank 111 pressurizes pure water supplied from the water supply pipe 115b to a predetermined value A1 (MP) and then feeds a predetermined flow B1 (l/min) of the pressurized pure water at a high pressure through the pressure hose 121 to the nozzle 101. The “pure water” here may be so-called water (pure water) characterized as pure water or ultrapure water used in cleaning steps of semiconductor device fabrication.

The water flowmeter 105 measures flowrates of the pure water supplied from the water-pressurizing tank 111 to the nozzle 101. An operator can confirm the flowrate on the water flowmeter 105 and uses the operative valve 103 to adjust it to a desired value. Also, by opening or closing the stop valve 107a, the supply of the pure water may be stopped or restarted.

The water vapor supplier 113 heats the pure water supplied from the water supply pipe 115a to a predetermined temperature D1 (° C.) or higher to produce water vapor and pressurizes the pure water to a predetermined value C1 (MP) by the amount of the water vapor produced, before feeding it at a high pressure through the pressure hose 123 to the nozzle 101.

The pressure meter 120 measures the pressure of the water vapor supplied from the water vapor supplier 113 to the nozzle 101. An operator can confirm the pressure on the pressure meter 120 and uses the pressure reducing valve 119 to adjust it to a desired value. Also, by opening or closing the stop valve 107b, the supply of the water vapor may be stopped or restarted.

In the nozzle 101, thermal effect phenomenon occurs by the pure water supplied from the water-pressurizing tank 111 and the water vapor supplied from the water vapor supplier 113. Cavitation jet produced by the thermal effect phenomenon will then be sprayed onto the surface of the object to be treated. High impact produced when air bubbles from the cavitation break up will then erode the surface of the object to be treated to provide treatments such as cleaning, polishing and grinding to remove unwanted matters.

In FIG. 1, nitrogen may be supplied from the nitrogen supply pipe 117 to the water-pressurizing tank 111. In this manner, water to which other gases or chemicals (for example, CO₂, O₃, N₂, O₂, H₂, alkalis, acids, surface active agents and the like) are added may be used to enhance the cleaning power or polishing or grinding rates. Although the pure water is mixed with nitrogen or the like in this embodiment, it is to be appreciated that pure water may only be supplied to the nozzle 101.

Nozzle Configuration

FIGS. 2 (a), (b) and (c) illustrate, in section, specific examples of nozzle configurations preferably used in one embodiment of a device for treating objects according to the present invention.

First, the nozzle 101a in FIG. 2 (a) has two flow channels (121 and 123) that are connected for letting in fluids from outside into internal space a3 of an approximately cylindrical nozzle body a1 having its top closed, the internal space a3 by way of which such fluids are passed where the fluids are mixed, and an outlet a2 circular in section for blowing out the mixed fluids downward. Two outlets (v1 and w1) are provided on the inner wall of the nozzle body a1, through which the fluids are let into the internal space a3.

The outlet v1 is connected through a pressure hose (flow channel) 123 to a water vapor supplier 113 to spurt water vapor and the outlet w1 is connected through a pressure hose (flow channel) 121 to a water-pressurizing tank 111 to spurt pure water (DIW) so that the water vapor and the pure water may be mixed in the internal space a3 to be blown out from the outlet a2.

In FIG. 2 (a), the outlets (v1 and w1) provided open into the nozzle 101a, first v1 and then w1, in the order of proximity to the downward outlet a2 are positioned in such a manner that they are perpendicular to the direction of spurting from the outlet a2. The profile (section) of the outlet of the nozzle in one example may be in the shape of a slit-like flattened ellipse or rectangle with a sectional area of 12 mm² corresponding to 2 mm×6 mm. When spurting is made from the outlet to an object, a guide member may be provided to adjust the downwardly flared spray angle, which may be 120°, for example.

A nozzle 101b in FIG. 2 (b) has an approximately cylindrical nozzle body b1 having a released (opened) part of its top and side. Internal space b3 of the body has two flow channels (121′ and 123′) connected for letting in respective fluids from the top and side on the plane of the drawing. The fluids are spurted into the internal space b3 to be mixed before being blown out downwardly from the outlet b2.

An outlet v2 provided open on the top of the nozzle body b1 is connected through a pressure hose (flow channel) 123′ to a water vapor supplier 113 to spurt water vapor therethrough. Pure water (DIW) is led by a pressure hose (flow channel) 121′ connected to a water-pressurizing tank 111 through an outlet w2 provided open on part of the sidewall of the nozzle body b1 to be spurted into the internal space b3.

A nozzle 101c in FIG. 2 (c) has an approximately cylindrical nozzle body c1 having a released (opened) part of its top and side. Internal space c3 of the body has two flow channels (121″ and 123″) connected for letting in respective fluids from the top and side on the plane of the drawing. The flow channel 123″ provided on the side of the nozzle body c1 spurts a fluid through its outlet v3 into the internal space c3 and the flow channel 121″ penetrates into the internal space c3 from above the nozzle body c1, having an outlet w3 at a position lower in the internal space c3 to spurt a fluid therethrough. The fluids are spurted into the internal space c3 from the outlets v3 and w3 to be mixed at a position lower in the internal space c3 before being blown out downwardly through an outlet c3.

The outlet v3 open on the sidewall is connected through a pressure hose (flow channel) 123″ to a water vapor supplier 113 to spurt water vapor therethrough. Also, a pressure hose 121″ led to the inside from the top of the nozzle body b1 is connected to a water-pressurizing tank 111, through which pure water (DIW) is led into the internal space c3. The water vapor and the pure water (DIW) are mixed at a position immediately below the outlet w3 at the lower end of the pressure hose 121″ to be spurted downwardly through the outlet c2.

In any of FIGS. 2 (a), (b) and (c), the profile (section) of the outlets (a2, b2 and c2) of the nozzle section is, for example, in the shape of a slit-like flattened ellipse or rectangle with a sectional area appropriately set in the range of from 1 to 100 mm² to be used. Profiles of the outlets of the nozzle section are not particularly limited to those above described and circular (round) profiles may also be used. When a round nozzle was used having a nozzle diameter of from 3 to 10 mm φ as the internal diameter of the outlet, the spurting area (sectional area) of the outlet would be from 9.42 to 78.5 mm².

Relative Operation (Scan Operation) Between Nozzle Section and Stage Section (Section for Positioning Object)

FIG. 3 is a view for illustrating relative operation between a nozzle section 201 and a stage section 231, that is, scan operation, wherein a treatment chamber 300 comprises a stage section 231 for positioning and holding an object to be treated 233 under a predetermined atmosphere, a nozzle section 201 for mixing water vapor supplied from a flow channel 223 and pure water supplied from a flow channel 221 within itself to spray the object 233 and a flow channel 301 for waste fluids and exhaust gases at the lower part.

The object to be treated 233 (for example, approximately disk-like semiconductor wafer) will be placed on the stage section 231 and the object 233 may be integrally bonded to the stage section 231 by fixing or anchoring means so that it may not be displaced during treatment. The stage section 231 is firmly supported by a support shaft 231′ extending downwardly from its center and is configured to operate in the same way as if it were integral with the support shaft 231′ according to rotation or revolution action of the support shaft 231′. In FIG. 3, the direction of operation is designated as R1 when the stage section 231 and the object 233 make rotations.

The nozzle section 201 sprays the top surface of the object 233 on the stage section 231 in the vertical direction. The distance between the nozzle outlet 201c and the top surface of the object 233 is designated as gap G. The nozzle section 201 is designed to be movable in itself, capable of performing rotation (revolution) and/or displacement operations. In FIG. 3, the nozzle stage 201 is capable of moving linearly in the horizontal direction from the central position c1 on the stage section 231 to the end position T1 while retaining the gap G at a predetermined value, with the trajectory (direction) of movement designated as M1.

In FIG. 3, the nozzle section 201 makes regular and linear movement (direction of operation M1) and the stage section 231 makes regular rotation (direction of operation R1) so that spraying may be performed while allowing the nozzle section 201 to regularly and continuously scan the whole treatment area on the object 233. The scan rate can be controlled to a desired value based on the positional relationship between the nozzle section 201 and the stage section 231.

In the description above, the nozzle section 201 and the stage section 231 are simultaneously moved so that the movement of the nozzle section 201 and the rotation of the stage section 231 may be synchronized to perform scanning of the object 233 and obtain a desired scan rate. It is however not limited thereto. Specifically, the nozzle section 201 may only be moved while the stage section 231 is fixed to combine movement and revolution so that the whole area to be treated of the object 233 may be scanned. Alternatively, the stage section 231 may only be moved while the nozzle section 201 is fixed to provide a mechanism capable of providing movement as well as revolution to synchronously combine the revolution and the movement so that the whole area to be treated of the object 233 may be scanned. Thus, the operations of the nozzle section 201 and the stage section 231 may be combined as appropriate in accordance with scanning specification so that a desired scanning rate may be obtained.

Regarding Object to be Treated

In Case Object to be Treated is “Circular”

When an object to be treated is circular in one embodiment of the present invention, control is made so that the whole area of one face of the object may evenly be scanned as a surface to be treated. For example, linear movement of the nozzle section 201 in a direction from the center to the circumference of the circular object may be combined with rotation movement of the stage section 231 to obtain a desired scan rate, with the trajectory of the scanning being a dense spiral.

In Case Object to be Treated is Rectangular

When an object to be treated is rectangular in one embodiment of the present invention, control is also made so that the whole area of one face of the object may evenly be scanned as a surface to be treated. FIGS. 4 (a) and (b) show scanning situations of a rectangular object.

FIG. 4 (a) illustrates one example of a scanning trajectory on a rectangular object 233a, the trajectory S1 being obtained by moving one or both of the nozzle section 201 and the stage section 231. Also, FIG. 4 (b) illustrates one example of a scanning trajectory on a rectangular object 233b. For example, in a similar manner to the case of a circular object, linear movement of the nozzle section 201 in a direction from the center to the edge of the object is combined with rotation movement of the stage section 231 to obtain a desired scan rate, with the trajectory of the scanning also being a dense spiral.

According to the present invention, a device for treating objects or a process therefor as described above was used to conduct experiments for effectively removing unwanted matters from objects to be treated such as semiconductor wafers, IC's, microstructures and liquid crystals while varying parameter conditions for a number of samples, to collect a great number of data for comparison and examination among them. As a result, we have found that effectiveness in removing unwanted matters may extremely be enhanced for spraying on the basis of the present invention of vapor (water vapor) in combination with pure water by controlling values of the following parameters within specified ranges.

Values of the parameters in spraying objects according to the present invention may be controlled so that

the pressure of the vapor supplied to the nozzle section is from 0.1 to 0.5 MPa,

the flowrate of the ultrapure water supplied to the nozzle section is from 50 to 1000 cc/min,

the spray time is from 10 to 600 sec,

the area of an outlet of the nozzle section is from 1 to 100 mm²,

the scan rate is from 10 to 300 mm/sec, and

the gap between the nozzle outlet and the object is from 3 to 30 mm.

Next, each parameter used in treating objects according to the present invention is described.

Regarding Vapor Pressure

Pressures of the vapor to be supplied to the nozzle section are from 0.1 to 0.5 MPa as adaptive values. In the case with a value lower than the adaptive values, physical strength will decrease due to a decrease in hitting performance against reaction byproducts, failing to remove them. In the case with a value higher than the adaptive values, hitting performance will inadvertently be great, causing damages to films (structures). Also, hardening or modification will occur due to generation of heat that is more than necessary.

Regarding Pure Water Flowrate

Flowrates of the pure water (DIW) are from 50 to 1000 cc/min as adaptive values. In the case with a value lower than the adaptive values, steam will only be obtained with diameters of the particles blown out from the nozzle so small that hitting force component will decrease, failing to remove. In the case with a value higher than the adaptive values, diameters of the particles will be greater due to mixing of the vapor (steam) and the pure water (DIW), causing damages to films.

Regarding Spray Treatment Time

Spray times are from 10 to 600 sec as adaptive values. In the case with a value lower than the adaptive values, reaction byproducts are likely to remain. In the case with a value higher than the adaptive values, removal will be possible, but with a higher risk of causing other secondary problems due to influence by heat. Also, this parameter of spray time is a significant factor having direct influences on the throughput of a device and too long a spray time is a drawback.

Regarding Area of Outlet of Nozzle Section

Areas of the outlet of the nozzle section are from 1 to 100 mm² as adaptive values. In the case with a value lower than the adaptive value, the hitting force will partially be greater because of a smaller area of the outlet, but with a risk of causing damages to films (structures) and with a possibility of leaving unwanted matters not removed because of too small an area of the outlet. In the case with a value higher than the adaptive value, an area of the outlet will be so great that the mixture particles of the vapor (steam) and the pure water (DIW) blown out from the nozzle may diffuse, losing the hitting performance before reaching an object to make it difficult to remove unwanted matters.

Regarding Scan Rate

Scan rates are from 10 to 300 mm/sec as adaptive values. In the case with a value lower than the adaptive value, irradiation time will be longer due to inadvertent nozzle blowout per unit time, increasing the possibility of damaging more than removing unwanted matters by heat and excessive hitting force. Also, in the case with a value higher than the adaptive value, nozzle blowout time per unit time will be shorter with insufficient hitting force, making it unable to remove unwanted matters.

Gap Between Nozzle Outlet and Object

Gaps (distances) between a nozzle outlet and an object are from 3 to 30 mm as adaptive values. In the case with a value lower than the adaptive value, the blowout area from the nozzle will be small on the basis of the relationship between the object and the blowout distance, with a high possibility of leaving some of unwanted matter not removed. Also, in the case with a value higher than the adaptive value, the particle mixture of the vapor (steam) and the pure water (DIW) blown out from the nozzle will decrease its hitting performance before reaching an object, likely to fail to remove unwanted matters.

FIGS. 5 to 7 are views illustrating specific treatments applied to three objects having different configurations according to the present invention.

An object 500 as shown in FIGS. 5 (1) to (3) is a semiconductor device (wafer) having a highly dielectric layer as a layer to be treated, which is configured to have a thin-film layer consisting of a resist (mask) layer 11, a highly dielectric layer (BST or SBT) 12 and a metal layer 13 of AU or Pt, all stacked on a substrate 14.

FIG. 5 (1) shows the object 500 before being etched, wherein the resist (mask) layer 11 has a pore K1. Next, FIG. 5 (2) shows the same object after etching, wherein portion K1′ of the highly dielectric layer 12 directly below and in contact with the pore K1 of the resist (mask) layer 11 has been pored and a secondary reaction byproduct F1 has been generated on the wall of the portions (K1 and K1′) remaining as a fence. Then, FIG. 5 (3) shows the object treated according to the present invention by applying mixed spraying of vapor and pure water, wherein the resist (mask) layer 11 and the reaction byproduct F1 as an unwanted matter have been removed.

For a treatment for removing unwanted matters in a semiconductor device (wafer) 500 having a highly dielectric layer as a layer to be treated as shown in FIG. 5, high effective removal of the unwanted matters may be provided when spraying is controlled so that the pressure of the vapor is from 0.2 to 0.3 MPa, the flowrate of the ultrapure water is from 100 to 500 cc/min, the area of an outlet of the nozzle section is from 1 to 100 mm², the spray time is from 120 to 300 sec, the scan rate is from 40 to 100 mm/sec, and the gap is from 5 to 10 mm/sec.

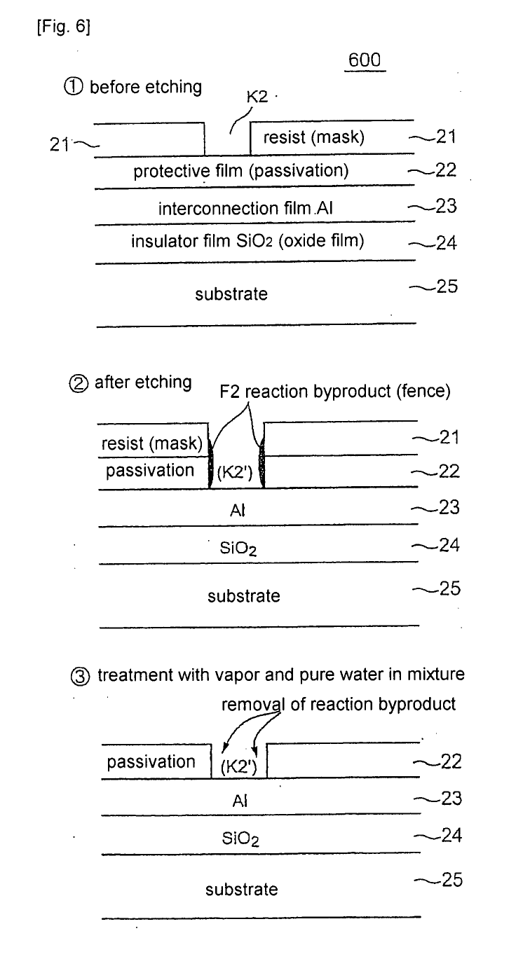

An object 600 as shown in FIGS. 6 (1) to (3) is a semiconductor device having a passivation film as a layer to be treated, which has a configuration suitable for wire bonding/bump. The object 600 is configured to have a thin-film layer consisting of a resist (mask) layer 21, a protective film (passivation film) 22, an interconnection film (Al) 23, and an insulation film (SiO₂ oxide film) 24, all stacked on a substrate 125.

FIG. 6 (1) shows the object 600 before being etched, wherein the resist (mask) layer 21 has a pore K2. Next, FIG. 6 (2) shows the same object after etching, wherein portion K2′ of the passivation film 22 directly below and in contact with the pore K2 of the resist (mask) layer 11 has been pored and a secondary reaction byproduct F2 has been generated on the wall of the portions (K2 and K2′), remaining as a fence. Then, FIG. 6 (3) shows the object treated according to the present invention by applying “mixed spraying of vapor and pure water”, wherein the resist (mask) layer 21 and the reaction byproduct F2 as an unwanted matter have been removed.

For a treatment for removing unwanted matters in a semiconductor device (wafer) having a passivation film as a layer to be treated as shown in FIG. 6, high effective removal of the unwanted matters may be provided when spraying is controlled so that the pressure of the vapor is from 0.15 to 0.3 MPa, the flowrate of the ultrapure water is from 100 to 500 cc/min, the area of an outlet of the nozzle section is from 1 to 100 mm², the spray time is from 60 to 120 sec, the scan rate is from 40 to 100 mm/sec, and the gap is from 5 to 10 mm/sec.

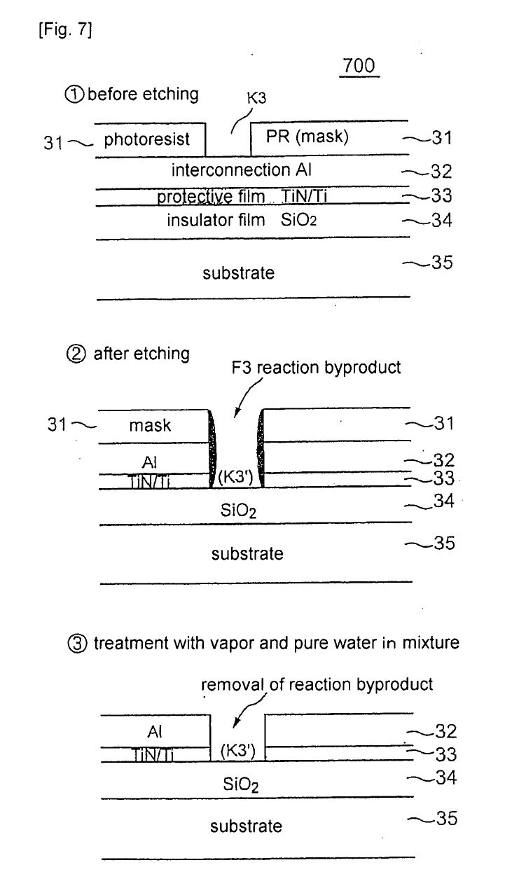

An object 700 as shown in FIGS. 7 (1) to (3) is a semiconductor device having metal layers as layers to be treated, which has a configuration wherein a pore is formed through the metal layers by etching. The object 700 is configured to have a thin-film layer consisting of a resist (mask) layer 31, an interconnection film (Al) 32, a protective film (Tw/Ti film) 33, and an insulation film (SiO₂ oxide film) 34, all stacked on a substrate 35.

FIG. 7 (1) shows the object 500 before being etched, wherein the resist (mask) layer 31 has a pore K3. Next, FIG. 6 (2) shows the same object after etching, wherein the interconnection film (Al) 32 and the protective film (Tw/Ti) 33 directly below and in contact with the pore K2 of the resist (mask) layer 31 have been pored and a secondary reaction byproduct F3 has been generated on the wall of the pored portions (K3 and K3′), remaining as a fence. Then, FIG. 7 (3) shows the object treated according to the present invention by applying “mixed spraying of vapor and pure water”, wherein the resist (mask) layer 31 and the reaction byproduct F3 as an unwanted matter have been removed.

For a treatment for removing unwanted matters in a semiconductor device (wafer) having an etching metal film as a layer to be treated as shown in FIG. 7, high effective removal of the unwanted matters may be provided when spraying is controlled so that the vapor pressure is from 0.1 to 0.2 MPa, the flowrate of the ultrapure water is from 100 to 500 cc/min, the area of an outlet of the nozzle section is from 1 to 100 mm², the spray time is from 30 to 120 sec, the scan rate is from 40 to 100 mm/sec, and the gap is from 5 to 10 mm/sec.

FIGS. 5 to 7 show, as three examples of objects, a semiconductor device having a highly dielectric layer (object 1), a semiconductor device having a passivation film suitable for wire bonding/bump (object 2) and a semiconductor device having a metal etching layer (object 3). As such, differences in treatment conditions for the objects will then be described.

Regarding Vapor Pressure

Vapor pressures are from 0.2 to 0.3 MPa, from 0.15 to 0.3 MPa and from 0.1 to 0.2 MPa for the objects 1, 2 and 3, respectively.

For the object 1, even when the vapor pressure is set at a higher value such as 0.3 MPa, since the highly dielectric film has characteristically high resistance to temperature involved in the vapor pressure, a high pressure setting will be possible with emphasis of hitting force. On the contrary, since aluminum used as interconnections for the objects 2 and 3 is likely to generate aluminum hydroxide easily due to the synergistic effect with temperature when the vapor density is high, they may be treated at pressures slightly lower than the pressures for treating the object 1.

Regarding Spray Time

Spray times for treatment are from 120 to 300 sec, from 60 to 300 sec and from 30 to 120 sec for the objects 1, 2 and 3, respectively.

For the object 2, since aluminum is used for the interconnections, treatment for 60 seconds or longer will cause aluminum hydroxide to be generated on the aluminum sidewall, damaging the aluminum surface. On the contrary, since the object 1 with a highly dielectric film uses no aluminum and the reaction byproduct is tough and difficult to remove, a longer time may preferably be used.

Though several embodiments of the present invention have been described above, the present invention is not limited to the above description and applications are possible for a variety of objects such as semiconductors, liquid crystals, magnetic heads, disks, printed substrates, lenses, precision-machined components, molded resin products and the like, in which treatments such as cleaning, polishing, removal of unwanted matters and like may more effectively and economically be performed.

Specifically, the present invention is also effective in the following technical fields.

(1) MEMS (Micro Electro Mechanical System)

The present invention is applied as means or a process for removing reaction byproducts or deburring in microstructures with the use of silicon processing technology.

(2) Liquid Crystal

The present invention is applied as means or a process for deburring since a process for manufacturing liquid crystals has many steps analogous with that for fabricating IC's.

(3) Molding

The present invention is applied as means or a process for deburring in a finishing step for IC fabrication.

### INDUSTRIAL APPLICABILITY

The present invention is applicable to objects such as semiconductor devices, liquid crystals, magnetic heads, disks, printed substrates, lenses for cameras and the like, precision-machined components, molded resin products and the like, in which treatments such as removal of unwanted matters, cleaning, polishing and the like may more effectively be performed and is also exploitable in the fields of microstructures, molding and the like with the use of silicon processing technology as means for deburring. Further, the present invention is especially suitable for treating materials not agreeable with chemicals.

### Explanation of Letters and Numerals

100: device for treating objects
101, 101a, 101b, 101c and 201: nozzle sections
a2, b2 and c3: outlets of nozzle sections
111: water-pressuring tank
113: water vapor supplier
123: water vapor supply tube (flow channel)
121: water supply tube (flow channel)
133 and 233: objects
131 and 231: stage sections (sections for positioning objects)
300: treatment chamber
500, 600 and 700: objects to be treated
K1, K1′, K2, K2′, K3 and K3′: pores
F1, F2 and F3: reaction byproducts (fences)

1. A device for treating an object, comprising
a section for positioning an object;
a nozzle section for spraying the object with supplied vapor and water in mixture; and
means for controlling relative rate of travel to a desired value during the spraying while moving the nozzle section in relation to the object on the section for positioning an object by regularly changing positional relationship between the section for positioning an object and the nozzle section.

2. The device for treating an object according to claim 1, wherein the object is any one of a semiconductor substrate, glass substrate, lens, disk member, precision-machined member and molded resin member, and
wherein the treatment of the object is cleaning of a portion or surface to be treated or removal of unwanted matters present on the portion or surface.

3. The device for treating an object according to claim 1, wherein the section for positioning an object is provided with a stage type positioning member or a conveyor type positioning member for performing one or more of rotation, revolution and transfer.

4. The device for treating an object according to any one of claim 1, wherein the object is a semiconductor device having any one of a highly dielectric layer, a passivation film and a metal layer as the portion or the surface to be treated, and
the device is characterized in that it removes, as an unwanted matter, any one of
1) a reaction byproduct produced after treating the highly dielectric layer with etching,
2) a reaction byproduct produced after treating the passivation film with etching, and
3) a reaction byproduct produced after treating the metal layer with etching.

5. A process for treating an object, comprising the steps of
placing an object on a section for positioning an object;
spraying the object with supplied vapor and water in mixture through a nozzle section; and
controlling relative rate of travel to a desired value during the spraying while moving the nozzle section in relation to the object on the section for positioning an object by regularly changing positional relationship between the section for positioning an object and the nozzle section.

6. The device for treating an object according to claim 2, wherein the section for positioning an object is provided with a stage type positioning member or a conveyor type positioning member for performing one or more of rotation, revolution and transfer.

7. The device for treating an object according to claim 6, wherein the object is a semiconductor device having any one of a highly dielectric layer, a passivation film and a metal layer as the portion or the surface to be treated, and
the device is characterized in that it removes, as an unwanted matter, any one of
1) a reaction byproduct produced after treating the highly dielectric layer with etching,
2) a reaction byproduct produced after treating the passivation film with etching, and
3) a reaction byproduct produced after treating the metal layer with etching.

8. The device for treating an object according to claim 2, wherein the object is a semiconductor device having any one of a highly dielectric layer, a passivation film and a metal layer as the portion or the surface to be treated, and
the device is characterized in that it removes, as an unwanted matter, any one of
1) a reaction byproduct produced after treating the highly dielectric layer with etching,
2) a reaction byproduct produced after treating the passivation film with etching, and
3) a reaction byproduct produced after treating the metal layer with etching.

9. The device for treating an object according to claim 3, wherein the object is a semiconductor device having any one of a highly dielectric layer, a passivation film and a metal layer as the portion or the surface to be treated, and
the device is characterized in that it removes, as an unwanted matter, any one of
1) a reaction byproduct produced after treating the highly dielectric layer with etching,
2) a reaction byproduct produced after treating the passivation film with etching, and
3) a reaction byproduct produced after treating the metal layer with etching.
